(19) United States
(12) Patent Application Publication
(10) Pub. No.: US 2025/0060059 A1
(43) Pub. Date: Feb. 20, 2025

(54) HOSE FITTING

(71) Applicant: Altraco, LLC, Calabasas, CA (US)

(72) Inventor: Scott Williams, Calabasas, CA (US)

(73) Assignee: Altraco, LLC, Calabasas, CA (US)

(21) Appl. No.: 18/235,190

(22) Filed: Aug. 17, 2023

(51) Int. Cl. F16L 33/30

(52) U.S. Cl. CPC F16L 33/30

(57) ABSTRACT

A hose fitting comprising a first barbed component having an elongated body defining a first end and a second end opposite the first end, the elongated body defining an axis of elongation and an exterior surface; the first barbed component first end being in fluid communication with the second end; an O-ring receptacle proximate the first end; a shoulder proximate the second end, the first shoulder extending outwardly from the exterior surface and defining an abutment surface normal to the axis of elongation; at least one annular barb between the O-ring receptacle and the shoulder, the annular barb extending outwardly from the exterior surface; and at least one engagement array defined by a plurality of studs arrayed to define a broken annulus wherein each of the studs defining the broken annulus extends outwardly from the exterior surface.

### CROSS-REFERENCE TO RELATED APPLICATION

This application does not claim the benefit of any other application.

### INTRODUCTION

The present subject matter pertains generally to a hose fitting and a method of connecting a hose to a hose fitting.

Hoses are flexible conduits used to provide a fluid flow path. These fluid flow paths may be substantially leak free, as in a hose adapted to deliver saline to a patient from a saline supply bag, or lossy, as in a sprinkler hose adapted to deliver irrigation water to a lawn or garden along the path of the hose. Hoses are commonly composed of an elastomeric tube having a circular or elliptical cross-section and optionally reinforced with one or more mesh or protective layers. A common type of hose is a garden hose. Garden hoses are typically available commercially in 0.5 inch, 0.625 inch, and 0.75 inch nominal diameters.

Joining a hose to a hose fitting is a common task of interest. A hose fitting may provide substantially fluid tight connection from a first connected hose to a second hose, or to a threaded component, or to another type of component. A hose fitting may have a barbed insert adapted to be inserted into a hose end and then over-clamped with a shrouding component around the hose to provide a substantially fluid tight connection between the hose and the barbed insert.

Because it is desirable to produce light-weight, inexpensive, reliable hose fittings, it remains desirable to produce a hose fitting which can provide a substantially fluid tight connection between the hose and the barbed insert without the need for the cost and weight of a shrouding component around the hose.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Provided is a hose fitting comprising a first barbed component having an elongated body defining a first end and a second end opposite the first end, the elongated body defining an axis of elongation and an exterior surface; the first barbed component first end being in fluid communication with the second end; an O-ring receptacle proximate the first end; a shoulder proximate the second end, the first shoulder extending outwardly from the exterior surface and defining an abutment surface normal to the axis of elongation; at least one annular barb between the O-ring receptacle and the shoulder, the annular barb extending outwardly from the exterior surface; and at least one engagement array defined by a plurality of studs arrayed to define a broken annulus wherein each of the studs defining the broken annulus extends outwardly from the exterior surface.

Still other embodiments of the present subject matter will become readily apparent to those skilled in this art from the following description wherein there is shown and described the embodiments of the present subject matter, simply by way of illustration of the best modes suited to carry out the present subject matter. As it will be realized, the present subject matter is capable of other different embodiments and its several details are capable of modifications in various obvious aspects all without departing from the scope of the present subject matter. Accordingly, the drawing and descriptions will be regarded as illustrative in nature and not as restrictive.

### BRIEF DESCRIPTION OF THE DRAWINGS

Various exemplary embodiments of the present subject matter will be described in detail, wherein like reference numerals refer to identical or similar components, with reference to the following figures, wherein:

FIG. 1 is a perspective view of a first embodiment of a hose fitting.

FIG. 2 is an end view of the first embodiment of a hose fitting from FIG. 1.

FIG. 3 is a cross-sectional view of the first embodiment of a hose fitting along section 3-3 shown in FIG. 2.

FIG. 4 is a cross-sectional view of the first embodiment of a hose fitting along section 4-4 shown in FIG. 2.

FIG. 5 is a side view of the first embodiment of a hose fitting from FIG. 1.

FIG. 6 is a view of a hose fitting with a male garden hose fitting.

FIG. 7 is a view of a hose fitting with a female garden hose fitting.

FIG. 8 is a view of a hose.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of the subject matter and the claims.

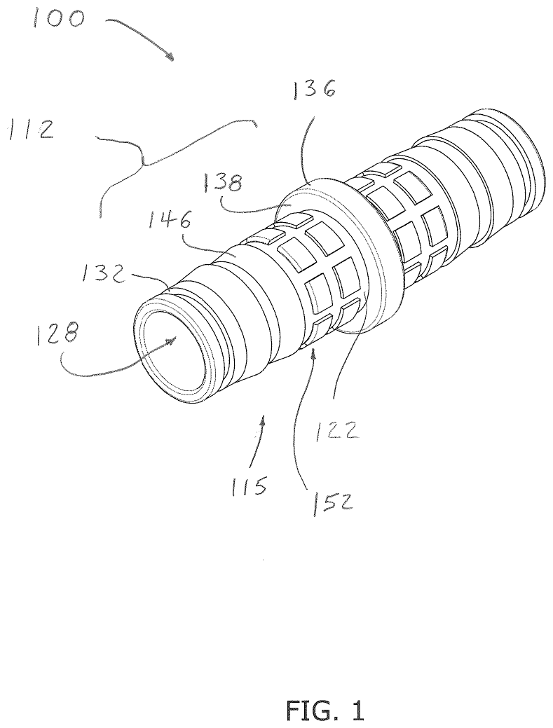

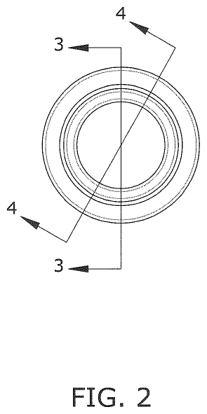

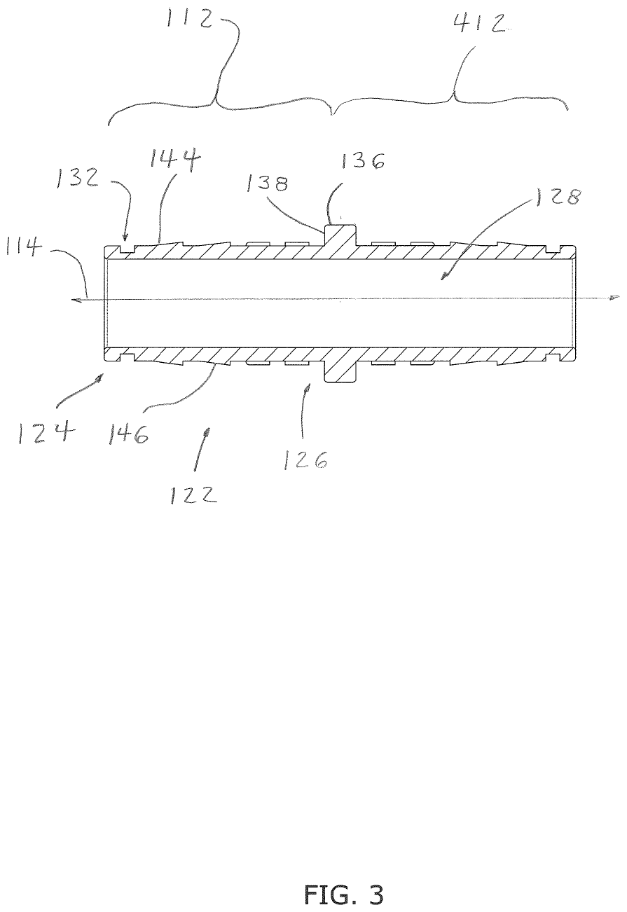

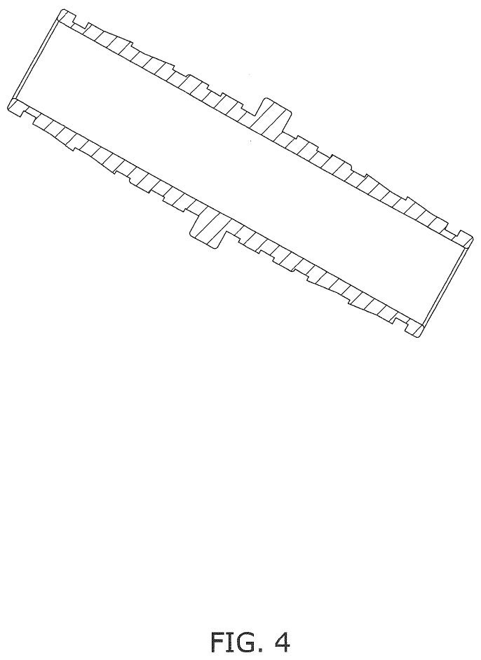

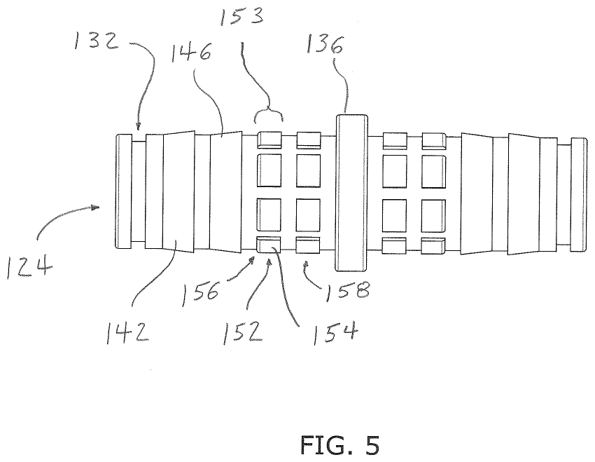

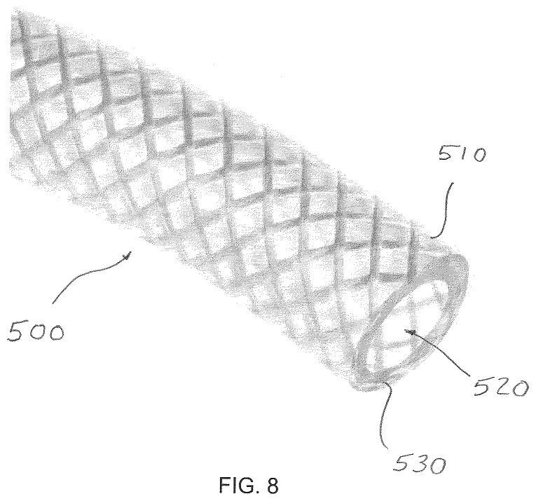

Referring to FIGS. 1-5 shown is a first embodiment of a hose fitting 100. The hose fitting 100 comprises a first barbed component 112. With additional reference to FIG. 8, the first barbed component 112 is adapted to be operationally engaged with an associated hose 500 to provide substantially fluid tight engagement therewith. The nature of this latter operational engagement will be addressed herebelow. The first barbed component 112 has a first substantially cylindrical elongated body 122 defining a first barbed component first end 124 and a first barbed component second end 126 opposite the first barbed component first end 124. The first substantially cylindrical elongated body 122 further defines and extends along a first barbed component axis of elongation 114. In the embodiment shown, the first barbed component axis of elongation 114 is linear, but it need not be perfectly straight and some curvature of the axis of elongation 114 may be acceptable: it is sufficient that it be substantially straight. In general, as used herein and unless otherwise noted, substantial compliance to a geometric form is that compliance that would satisfy engineering manufacturing tolerances within 0.01 inch or 0.1 degree. With continued reference to FIGS. 1-5, the first substantially cylindrical elongated body 122 further defines a first barbed component exterior surface 115.

With continued reference to FIGS. 1-5, the first barbed component 112 may further comprise a first barbed component first end 124 is in fluid communication with the first barbed component second end 126. In the non-limiting embodiment shown in FIGS. 1-5, fluid communication between the first barbed component first end 124 and the first barbed component second end 126 is through a first barbed component elongated hole 128 extending therebetween.

With continued reference to FIGS. 1-5, the first barbed component 112 may further comprise an optional first barbed component O-ring receptacle 132 proximate the first barbed component first end 124. In the non-limiting embodiment shown the first barbed component O-ring receptacle 132 is adapted to accept and operationally engage an associated O-ring defined by an open groove in the first barbed component exterior surface 115. With further reference now to FIG. 8, the latter operational engagement provides for the associated O-ring to establish a substantially fluid tight seal between the first barbed component 112 and an associated hose 500, while still permitting the the first barbed component 112 to be operationally inserted into the hose cavity 520. It is to be understood that there are other embodiments of a first barbed component O-ring receptacle 132 similarly adapted to operationally engage an associated O-ring that would be similarly acceptable.

With continued reference to FIGS. 1-5, the first barbed component 112 may further comprise an optional first barbed component shoulder 136 proximate the first barbed component second end 126. The first barbed component shoulder 136 may extend outwardly from the first barbed component exterior surface 115. The first barbed component shoulder 136 may be any size and shape. The first barbed component shoulder 136 may define a first barbed component abutment surface 138. The first barbed component abutment surface 138 may be any size and shape. As shown in FIGS. 1-5, the first barbed component abutment surface 138 may be substantially normal to the first barbed component axis of elongation 114, but some deviation from this latter direction are also contemplated and may also be acceptable including, but not limited to, a direction within 5 degrees of normal to the first barbed component axis of elongation 114. As noted above, and with additional reference here to FIG. 8, the first barbed component 112 is adapted to be operationally engaged with an associated hose 500 to provide substantially fluid tight engagement therewith. In this latter operational engagement, the first barbed component abutment surface 138 provides a physical limit to insertion of the first barbed component 112 into an associated hose 500 such that the first barbed component abutment surface 138 butts up against associated hose end 530 when the first barbed component 112 is fully inserted into associated hose cavity 520.

With continued reference to FIGS. 1-5, the first barbed component 112 may further comprise at least one first barbed component annular barb 142 between the first barbed component O-ring receptacle 132 and the first barbed component shoulder 136. The first barbed component annular barb 142 may be any size and shape. With additional reference now to FIG. 8, the at least one first barbed component annular barb 142 may extend outwardly from the first barbed component exterior surface with the amount of radial extension gradually changing with distance along the surface in the direction of the first barbed component axis of elongation 114 to form an inclined surface over which the associated hose wall 510 may be strained during insertion of the first barbed component 112 into the associated hose cavity 520. While the embodiment shown in FIGS. 1-5. shows the amount of radial extension gradually changing with distance along the surface in the direction of the first barbed component axis of elongation 114 in a substantially linear fashion, the change need not always be linear and alternative forms, including curved barbs, are contemplated. Other alternative forms contemplated are one or more annular barbs that wrap around the barbed component exterior surface in such a way as to form a helical barb. Without limitation, the at least one first barbed component annular barb 142 may comprise a first barbed component first annular barb 144 and a first barbed component second annular barb 146. It is understood that the strain on the associated hose 500 as it passes over an annular barb is temporary and relaxes readily once the strained region of the associated hose 500 passes over the annular barb so that the associated interior cavity 520 of the associated hose 500 substantially conforms to the first barbed component exterior surface 115 and such that the at least one first barbed component annular barb 142 creates resistance to removal of the first barbed component 112 from the associated hose 500, thereby promoting operational engagement therebetween.

With continued reference to FIGS. 1-5, the first barbed component 112 may further comprise at least one first barbed component engagement array 152 defined by a plurality of studs 154 arrayed to define a broken annulus 153 wherein each of the studs 154 defining the broken annulus 153 extends outwardly from the first barbed component exterior surface 115.

The first barbed component array 152 may be any size and shape and include any number of studs 154. The studs 154 may be any size and shape. The first barbed component array 152 may be symmetrical or asymmetrical. The first barbed component 112 may further comprise a first barbed component second engagement array 158. The first barbed component second engagement array 158 may be any size and shape and may contain any number of studs 154. The studs 154 in the first barbed component second engagement array 158 may be the same as the studs in the first barbed component array 152. Optionally the studs 154 in each array 156, 158 may be different numbers, shapes, or configuration.

The applicant has found that inclusion of the engagement array results in substantially improved engagement characteristics between the hose fitting 100 and the associated hose 500 such that operational engagement can be created and maintained under conventional water flow through a variety of associated commercial garden hoses to provide a substantially fluid tight connection between the associated hose 500 and the hose fitting 100 without the need for a shrouding component around the associated hose 500. This obviates the cost and weight of any shrouding component around the associated hose 500 in order to create and maintain the desired fluid tight connection between the associated hose 500 and the hose fitting 100. Without wishing to be bound by any particular theory, the applicant believes that the breaks between the studs provide a gap which the elastomeric material of hose substantially conforms to. This compliance creates additional material to be displaced or strained in order to pull out the hose fitting out of operational engagement with the associated hose 500, and because such strain requires the input of energy, this creates a higher energy input to remove the hose fitting from operational engagement with the associated hose 500. Informal testing has shown that, at room temperature and humidity, a conventional barbed hose fitting installed in a conventional garden hose without a shrouding component around the associated hose 500 can be pulled out by a fit man without observable damage to the conventional barbed hose fitting or the associated hose 500. By contrast informal testing has shown that a conventional barbed hose fitting installed in a conventional garden hose without a shrouding component around the associated hose 500 can be pulled out by a fit man only with great difficulty and that such pull out damages the associated hose 500. Applicant asserts that it is the specific geometry of the hose fitting 100 that makes it difficult, if not impossible, to pull the hose 500 apart without damage to the hose 500. Without limitation, the at least one first barbed component engagement array 152 may comprise a first barbed component first engagement array 156 and a first barbed component second engagement array 158.

The first barbed component array 152 may comprise a first engagement array 156 and a second engagement array 158. The first engagement array 156 may be any size and shape and may contain any number of studs 154. The studs 154 in the first engagement array 156 may be the same as the studs 154 in the second engagement array 158. Optionally the studs 154 in each array 152, 158 may be different numbers, shapes, or configuration. The second engagement array 158 may be any size and shape and may contain any number of studs 154.

It should be understood that arrangement of the above referenced surface features is subject to good engineering judgment. In some embodiments and without limitation, the first barbed component first annular barb 144 and the first barbed component second annular barb 146 are between the first barbed component O-ring receptacle 132 and the first barbed component first engagement array 156 and the first barbed component second engagement array 158.

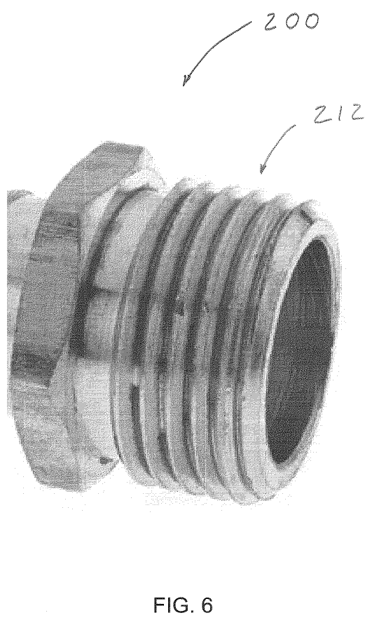

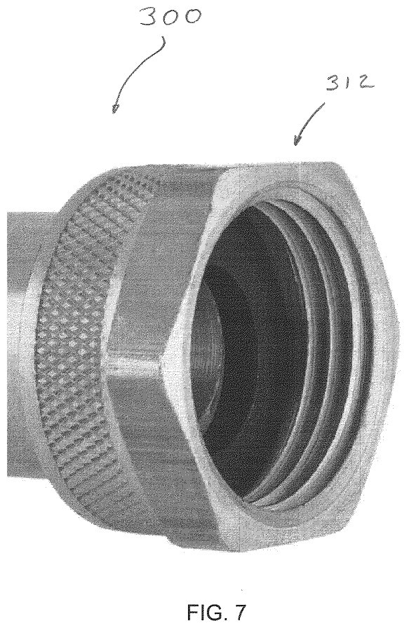

It is contemplated that the above subject matter first barbed component 112 may be of a variety of diameters and may be formed with or connected to a variety of components adapted for use with a variety of associated conventional hoses and associated conventional hose fittings and/or components to yield a great variety of hose fittings. Examples of these latter hose fittings include hose fitting 100 in which a first barbed component 112 is operationally engaged with a second fitting which may be a second barbed component 412, or a male garden hose fitting, or a female garden hose fitting. As shown in FIGS. 1-5, a second barbed component may be substantially similar to a first barbed component 112, but it should be understood that differences in diameter, number of surface features, and arrangement of surface features are contemplated. With additional reference now to FIG. 6, for these purposes and unless otherwise noted, a male hose fitting 200 or a standard threaded male garden hose fitting 212 is one compliant with NH (“National Hose”) defined in ANSI B1.20.7-1991. With additional reference now to FIG. 7, for these purposes and unless otherwise noted, a female hose fitting 300 or a standard threaded female garden hose fitting 312 is one compliant with NH (“National Hose”) defined in ANSI B1.20.7-1991. For these purposes and hereafter unless otherwise noted, operational engagement may be by forming both unitarily from the same material such as by casting or injection molding but it is contemplated that separate components may be formed and then operationally engaged by welding, soldering, brazing, application of an adhesive, by one or more mechanical fasteners, or by other means chosen with good engineering judgment. It should further be understood that a barbed component may be adapted for operational engagement with a conventional commercial ½ inch diameter garden hose, or a conventional commercial ⅝ inch diameter garden hose, or a conventional commercial ¾ inch diameter garden hose.

Accordingly, the contemplated combinations of components include, but are not limited to the following. 1) A hose fitting formed from a first barbed component adapted for operational engagement with a conventional commercial ½ inch diameter garden hose in operational engagement with any of: a second barbed component adapted for operational engagement with a conventional commercial ½ inch diameter garden hose; a second barbed component adapted for operational engagement with a conventional commercial ⅝ inch diameter garden hose; a second barbed component adapted for operational engagement with a conventional commercial ¾ inch diameter garden hose; a male garden hose fitting; or a female garden hose fitting. 2) A hose fitting formed from a first barbed component adapted for operational engagement with a conventional commercial ⅝ inch diameter garden hose in operational engagement with any of: a second barbed component adapted for operational engagement with a conventional commercial ⅝ inch diameter garden hose; a second barbed component adapted for operational engagement with a conventional commercial ¾ inch diameter garden hose; a male garden hose fitting; or a female garden hose fitting. 3) A hose fitting formed from a first barbed component adapted for operational engagement with a conventional commercial ¾ inch diameter garden hose in operational engagement with any of: a second barbed component adapted for operational engagement with a conventional commercial ¾ inch diameter garden hose; a male garden hose fitting; or a female garden hose fitting.

It should be understood that dimensions and manufacturing tolerances for the above referenced features is subject to good engineering judgment. In some embodiments and without limitation, in a barbed component adapted for operational engagement with a conventional commercial ¾ inch diameter garden hose, the first barbed component exterior surface has an exterior diameter of between 0.68 inches and 0.77 inches. In some embodiments and without limitation, in a barbed component adapted for operational engagement with a conventional commercial ⅝ inch diameter garden hose, the first barbed component exterior surface has an exterior diameter of between 0.56 and 0.65 inches. In some embodiments and without limitation, in a barbed component adapted for operational engagement with a conventional commercial ½ inch diameter garden hose, the first barbed component exterior surface has an exterior diameter of between 0.44 inches and 0.52 inches.

What has been described above includes examples of the claimed subject matter. It is not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such a term is intended to be inclusive in a manner similar to the term “comprising” as “comprising” is interpreted when employed as a transitional word in a claim.

The foregoing method descriptions and the diagrams are provided merely as illustrative examples and are not intended to require or imply that the steps of the various embodiments must be performed in the order presented. As will be appreciated by one of skill in the art, some of the steps in the foregoing embodiments may be performed in a different order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

1. A hose fitting comprising
a first barbed component, the first barbed component having
a first substantially cylindrical elongated body defining a first barbed component first end and a first barbed component second end opposite the first barbed component first end, the first substantially cylindrical elongated body defining and extending along a first barbed component axis of elongation, the first substantially cylindrical elongated body defining a first barbed component exterior surface;
the first barbed component first end being in fluid communication with the first barbed component second end;
a first barbed component O-ring receptacle proximate the first barbed component first end;
a first barbed component shoulder proximate the first barbed component second end, the first barbed component shoulder extending outwardly from the first barbed component exterior surface, the first barbed component shoulder defining a first barbed component abutment surface substantially normal to the first barbed component axis of elongation;
at least one first barbed component annular barb between the first barbed component O-ring receptacle and the first barbed component shoulder, the at least one first barbed component annular barb extending outwardly from the first barbed component exterior surface; and the at least one first barbed component engagement array defined by a plurality of studs arrayed to define a broken annulus wherein each of the studs defining the broken annulus extends outwardly from the first barbed component exterior surface.

2. The hose fitting of claim 1, wherein the first substantially cylindrical elongated body defines a first barbed component elongated hole therein extending from the first barbed component first end to the first barbed component second end.

3. The hose fitting of claim 2, wherein the at least one first barbed component annular barb comprises a first barbed component first annular barb, and a first barbed component second annular barb.

4. The hose fitting of claim 3, wherein the at least one first barbed component engagement array comprises a first barbed component first engagement array and a first barbed component second engagement array.

5. The hose fitting of claim 4, wherein the first barbed component first annular barb and the first barbed component second annular barb are between the first barbed component O-ring receptacle and the first barbed component first engagement array and the first barbed component second engagement array.

6. The hose fitting of claim 5, further comprising a standard threaded male garden hose fitting in fluid communication with the first barbed component second end.

7. The hose fitting of claim 6 wherein the first barbed component exterior surface has an exterior diameter of between 0.68 inches and 0.77 inches.

8. The hose fitting of claim 6 wherein the first barbed component exterior surface has an exterior diameter of between 0.56 and 0.65 inches.

9. The hose fitting of claim 6 wherein the first barbed component exterior surface has an exterior diameter of between 0.44 inches and 0.52 inches.

10. The hose fitting of claim 5, further comprising a standard threaded female garden hose fitting in fluid communication with first barbed component second end.

11. The hose fitting of claim 10 wherein the first barbed component exterior surface has an exterior diameter of between 0.68 inches and 0.77 inches.

12. The hose fitting of claim 10 wherein the first barbed component exterior surface has an exterior diameter of between 0.56 and 0.65 inches.

13. The hose fitting of claim 10 wherein the first barbed component exterior surface has an exterior diameter of between 0.44 inches and 0.52 inches.

14. The hose fitting of claim 5, further comprising a second barbed component operationally engaged with the first barbed component.

15. The hose fitting of claim 14 wherein the first barbed component exterior surface has an exterior diameter of between 0.68 inches and 0.77 inches.

16. The hose fitting of claim 14 wherein the first barbed component exterior surface has an exterior diameter of between 0.56 and 0.65 inches.

17. The hose fitting of claim 14 wherein the first barbed component exterior surface has an exterior diameter of between 0.44 inches and 0.52 inches.

18. A method of connecting a hose to a hose fitting comprising
providing a hose having a hose wall defining a hose cavity and a hose end;
providing a hose fitting having
a first barbed component, the first barbed component having
a first substantially cylindrical elongated body defining a first barbed component first end and a first barbed component second end opposite the first barbed component first end, the first substantially cylindrical elongated body defining and extending along a first barbed component axis of elongation, the first substantially cylindrical elongated body defining a first barbed component exterior surface,
the first barbed component first end being in fluid communication with the first barbed component second end,
a first barbed component O-ring receptacle proximate the first barbed component first end,
a first barbed component shoulder proximate the first barbed component second end, the first barbed component shoulder extending outwardly from the first barbed component exterior surface, the first barbed component shoulder defining a first barbed component abutment surface substantially normal to the first barbed component axis of elongation,
at least one first barbed component annular barb between the first barbed component O-ring receptacle and the first barbed component shoulder, the at least one first barbed component annular barb extending outwardly from the first barbed component exterior surface, and
the at least one first barbed component engagement array defined by a plurality of studs arrayed to define a broken annulus wherein each of the studs defining the broken annulus extends outwardly from the first barbed component exterior surface; and
inserting the first barbed component first end into the hose cavity.

19. The method of claim 18 wherein the hose fitting further comprises a member selected from the group consisting of:
a standard threaded male garden hose fitting in fluid communication with the first barbed component second end,
a standard threaded female garden hose fitting in fluid communication with the first barbed component second end, and
a second barbed component operationally engaged with the first barbed component.

20. A hose fitting comprising, first barbed component having
a first substantially cylindrical elongated body defining a first barbed component first end and a first barbed component second end opposite the first barbed component first end, the first substantially cylindrical elongated body defining and extending along a first barbed component axis of elongation, the first substantially cylindrical elongated body defining a first barbed component exterior surface;
the first barbed component first end being in fluid communication with the first barbed component second end;
a first barbed component O-ring receptacle proximate the first barbed component first end;
a first barbed component shoulder proximate the first barbed component second end, the first barbed component shoulder extending outwardly from the first barbed component exterior surface, the first barbed component shoulder defining a first barbed component abutment surface;
at least one first barbed component annular barb between the first barbed component O-ring receptacle and the first barbed component shoulder, the at least one first barbed component annular barb extending outwardly from the first barbed component exterior surface; and
a first barbed component engagement array between the first barbed component O-ring receptacle and the first barbed component shoulder, the first barbed component engagement array defined by a plurality of studs arrayed to define a broken annulus wherein each of the studs extends outwardly from the first barbed component exterior surface; and
wherein the studs are substantially rectangular.
